(19) United States
(12) Patent Application Publication
(10) Pub. No.: US 2025/0083571 A1
(43) Pub. Date: Mar. 13, 2025

(54) FUEL CELL VEHICLE THERMAL SYSTEM

(71) Applicant: FCA US LLC, Auburn Hills, MI (US)

(72) Inventors: Matthew T Bartlett, Northville, MI (US); Nicole Dunn, Waterford, MI (US); Evegenij Pticyn, Frankfort am Main (DE)

(21) Appl. No.: 18/466,346

(22) Filed: Sep. 13, 2023

(51) Int. Cl. B60L 58/33; H01M 8/04007; H01M 8/04014; H01M 8/04029; H01M 8/04223; H01M 8/04746

(52) U.S. Cl. CPC B60L 58/33; H01M 8/04014; H01M 8/04029; H01M 8/04074; H01M 8/04253; H01M 8/04768; H01M 2250/20

(57) ABSTRACT

A thermal management system for a vehicle having a fuel cell stack includes a condenser fluidly coupled to the fuel cell stack to receive a flow of water/air exhaust therefrom, and a liquid-gas separator fluidly coupled to the condenser to receive the flow of water/air exhaust therefrom, the liquid-gas separator including a first outlet to direct separated gas to an exhaust line, and a second outlet for separated liquid water. The spray nozzles are fluidly coupled to the separator second outlet to receive a flow of liquid water therefrom, and a coolant circuit is configured to circulate a coolant to the fuel cell stack for cooling thereof, the coolant circuit including a radiator configured to cool the coolant. The one or more spray nozzles are configured to selectively spray the liquid water onto the radiator to increase cooling of the coolant and improve performance of the fuel cell stack.

### FIELD

The present application relates generally to fuel cell vehicles and, more particularly, to a fuel cell vehicle with a water cooled thermal system.

### BACKGROUND

Some vehicles include proton exchange membrane (PEM) fuel cells for motive power. Such PEM fuel cells have the advantage of rejecting less total heat than internal combustion engines. However, the amount of heat rejected to the cooling system is higher and such cooling systems often have a reduced maximum allowable coolant temperature. Moreover, when PEM fuel cells are installed in vehicles designed for internal combustion engines, there is often insufficient space to install large enough radiators and fans to provide sufficient heat rejection capability for desired vehicle performance, such as towing a trailer on steep grades. As such, cooling system performance potentially limits vehicle performance. Accordingly, while such fuel cell systems work for their intended purpose, there is a desire for improvement in the relevant art.

### SUMMARY

In accordance with one example aspect of the invention, a thermal management system for a vehicle having a fuel cell stack is provided. In one example, the thermal management system includes a condenser fluidly coupled to the fuel cell stack to receive a flow of water/air exhaust therefrom, and a liquid-gas separator fluidly coupled to the condenser to receive the flow of water/air exhaust therefrom, the liquid-gas separator including a first outlet to direct separated gas to an exhaust line, and a second outlet for separated liquid water. One or more spray nozzles are fluidly coupled to the separator second outlet to receive a flow of liquid water therefrom, and a coolant circuit is configured to circulate a coolant to the fuel cell stack for cooling thereof, the coolant circuit including a radiator configured to cool the coolant. The one or more spray nozzles are configured to selectively spray the liquid water onto the radiator to increase cooling of the coolant and improve performance of the fuel cell stack.

In addition to the foregoing, the described thermal management system may include one or more of the following features: an external membrane humidifier configured to receive the flow of water/air exhaust from the fuel cell stack and humidify a flow of air into the fuel cell stack before supplying the water/air exhaust flow to the condenser; a three-way valve disposed upstream of the condenser and configured to selectively direct the flow of water/air exhaust to the condenser or the exhaust line; wherein the exhaust line includes a back pressure control valve; and wherein the liquid-gas separator is a pressurized accumulator vessel.

In addition to the foregoing, the described thermal management system may include one or more of the following features: wherein the liquid-gas separator includes a sensor configured to measure a liquid level in the liquid-gas separator; a pump disposed between the second outlet and the one or more spray nozzles, and a controller in signal communication with the sensor and the pump, the controller configured to control the flow of liquid water to the one or more spray nozzles based on the measured liquid level in the liquid-gas separator; and wherein when the measured liquid level meets or exceeds a predetermined full threshold, the controller commands the pump to provide a maximum flow rate to the one or more spray nozzles.

In addition to the foregoing, the described thermal management system may include one or more of the following features: wherein the controller is configured to operate the thermal management system in a Performance Mode where, based on GPS map-based route planning data and ambient temperature, the controller sets an RPM of the pump to ensure liquid water is available to the one or more spray nozzles during a predicted high load fuel cell operating event; wherein the controller is configured to operate the thermal management system in a Shut-Down Mode where the controller is configured to drain the liquid-gas separator if the ambient temperature is less than a predetermined threshold to thereby prevent freezing of the liquid water in the thermal management system; and wherein the controller is configured to operate the thermal management system in an Eco-Mode where, when the sensor indicates the liquid-gas separator is partially full, the controller is configured to supply liquid water to the one or more spray nozzles while reserving a portion of the liquid water to increase the water level in the liquid-gas separator for a predicted high-demand portion of a drive cycle.

In addition to the foregoing, the described thermal management system may include one or more of the following features: wherein the condenser is a tube and fin heat exchanger with an electric fan configured to cool the water/air exhaust via heat exchange with ram air flow and/or airflow generated by the electric fan; wherein the condenser is a tube heat exchanger configured to cool the water/air exhaust via heat exchange with ram air flow; wherein the condenser is a liquid cooled heat exchanger thermally coupled to a second coolant circuit of the vehicle; a drain valve disposed between the second outlet and the one or more spray nozzles, the drain valve configured to drain liquid water from the thermal management system to prevent damage thereof; wherein the radiator is disposed between an A/C condenser and one or more electric fans; and wherein the liquid-gas separator includes a filter configured to capture entrained liquid water particles in the flow of water/air exhaust supplied to the liquid-gas separator.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example thermal management system for a fuel cell vehicle, in accordance with the principles of the present application; and

FIG. 2 is a schematic illustration of an example liquid-gas separator shown in FIG. 1, in accordance with the principles of the present application.

### DETAILED DESCRIPTION

According to the principles of the present application, systems and methods are described for a thermal management system for a fuel cell powered electric vehicle. The thermal management system is configured to capture water created in a hydrogen fuel cell stack (FCS), and subsequently spray the product water onto a high temperature radiator for cooling of the thermal system. The thermal system also includes a condenser integrated with a back pressure control valve to regulate an operating pressure on a cathode side of the FCS. The thermal system may also include a water reservoir with a product water drain feature and a spray pump for operation at ambient temperatures below freezing.

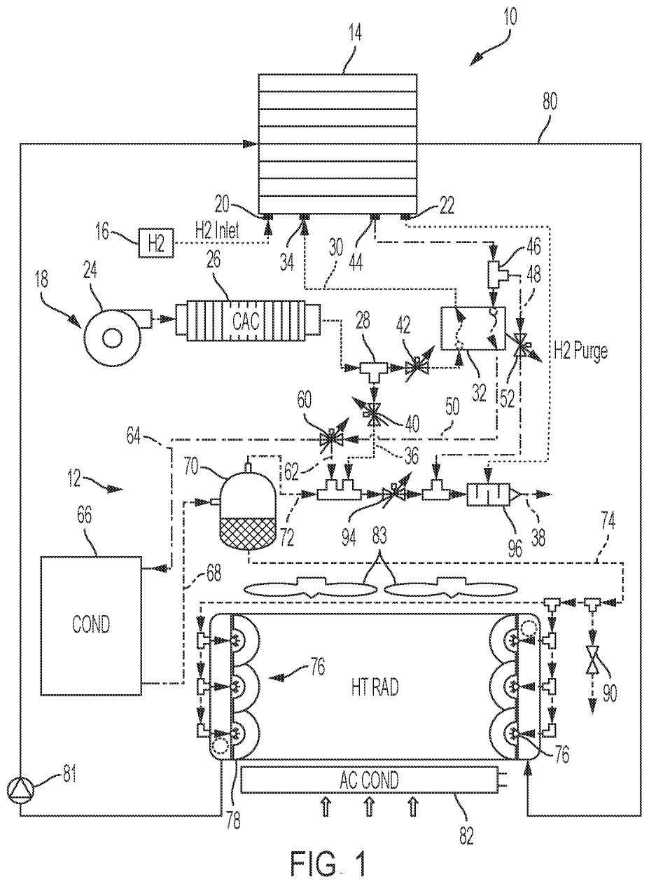

With reference now to FIG. 1, a vehicle fuel cell system 10 with an associated thermal management system 12 is illustrated in accordance with the principles of the present disclosure. The vehicle fuel cell system 10 generally includes a fuel cell stack 14, a hydrogen fuel source 16, and an oxygen fuel source 18. In the example embodiment, the fuel cell stack 14 is a proton exchange membrane (PEM) fuel cell stack formed by stacking a plurality of fuel cells, which are configured to generate electricity by electrochemical reactions of a fuel gas (e.g., hydrogen) and an oxygen containing gas (e.g., ambient air). As is well known in the art, each fuel cell includes an electrolyte membrane disposed between an anode and a cathode. It will be appreciated, however, that the thermal management system 12 described herein may be utilized with various other types of fuel cell systems.

The hydrogen fuel source 16 is fluidly coupled to the fuel cell stack 14 at an inlet 20, and unused hydrogen fuel is directed through an outlet 22. The oxygen fuel source 18 is provided by an air compressor 24, which compresses ambient air. The compressed and heated air is subsequently directed through a heat exchanger 26 (e.g., charge air cooler) for cooling thereof. The cooled and compressed air is then directed to a junction 28, where a first portion of compressed air is supplied through a conduit 30 to an external membrane humidifier 32 before entering the fuel cell stack 14 via an inlet 34. A second portion of the compressed air is directed through a conduit 36 to an exhaust line 38 for exhausting to the ambient environment. Valves 40, 42 are utilized to control the flow of compressed air through conduits 30, 36.

Once in the fuel cell stack 14, the compressed air reacts with the hydrogen fuel, which generates electricity and water byproduct (water product). The water product and unused air are then directed through an outlet 44 to a junction 46. A first portion of the water/air exhaust is directed through a conduit 48 to the exhaust line 38. A second portion of the water/air exhaust is directed via a conduit 50 to the membrane humidifier 32 where water vapor from the exhaust gas is transferred to the compressed air supplied to inlet 34 to maintain an optimal hydration level of the electrolyte membrane. The water/air exhaust is then directed to the integrated thermal management system 12. Valve 52 is utilized to control the flow of the water/air exhaust through conduit 48.

In the example embodiment, the thermal management system 12 is configured to utilize the water/air exhaust from the fuel cell stack 14 to cool the fuel cell stack 14 and maintain an optimal temperature thereof. The thermal management system 12 includes a three-way valve 60, which receives the water/air exhaust from conduit 50. The three-way valve 60 is configured to direct the received water/air exhaust either through a conduit 62 to the exhaust line 38, or through a conduit 64 to a condenser 66. The three-way valve 60 functions as a condenser bypass for vehicle operating conditions where the product water in the cathode exhaust stream could potentially freeze and block conduit 64. In one example, three-way valve 60 is configured to direct the received water/air exhaust to the condenser 66. When the ambient temperature falls below a predetermined threshold (e.g., 10° C.), the three-way valve 60 then directs the received water/air exhaust to the exhaust line 38 via conduit 62.

The condenser 66 is configured to condense water vapor present in the cathode exhaust stream. In one embodiment, the condenser 66 is an air cooled heat exchanger configured to cool the cathode exhaust stream by passing ambient air over the heat exchanger via ram air and/or a fan (not shown). In another embodiment, condenser 66 is an air cooled cathode exhaust tube condenser configured to cool the cathode exhaust stream by passing ambient air over the cathode exhaust tube. In yet another embodiment, condenser 66 is a liquid cooled heat exchanger thermally coupled to an existing cooling system of the vehicle, for example, that cools a traction battery.

The water/air exhaust stream is at least partially condensed in condenser 66 and subsequently directed via a conduit 68 to a pressurized, non-vented liquid-gas separator 70. In the example embodiment, the separator 70 is configured to separate the gas and liquid received from conduit 68. The separated gas is directed to the exhaust line 38 via a conduit 72. The separator 70 also functions as a liquid reservoir and is configured to direct the separated liquid product water to a supply conduit 74. A plurality of spray nozzles 76 are fluidly coupled to the supply conduit 74 and configured to selectively spray the product water onto a high-temperature radiator 78, which is thermally coupled to the fuel cell stack 14 for cooling thereof via coolant circuit 80 and pump 81. The product water sprayed onto the radiator 78 at least partially evaporates against the relatively hot radiator coolant, thereby increasing heat dissipation and reducing the radiator coolant temperature further than can be accomplished by air alone. The radiator 78 may be disposed between an A/C condenser 82 and one or more fans 83 to further improve evaporation, cooling, and airflow across the radiator 78.

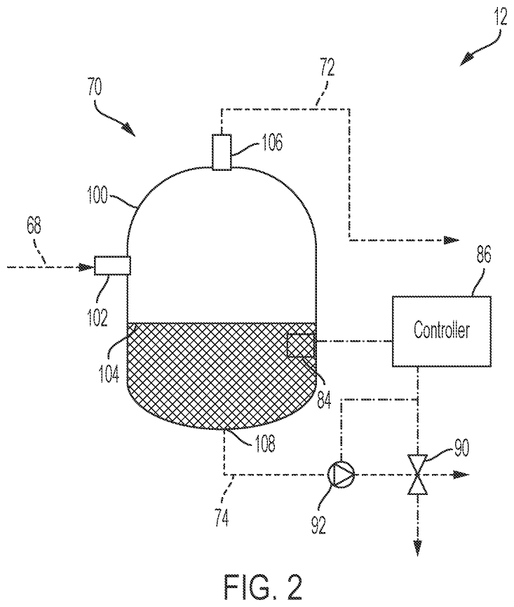

In some optional embodiments, shown in FIG. 2, the separator 70 includes a sensor 84 configured to measure a liquid level in the reservoir. The sensor 84 may be in signal communication with a controller 86 (e.g., fuel cell stack controller, FIG. 2). A drain valve 90 may be fluidly coupled to the supply conduit 74 and configured to drain product water when the vehicle is not operating and ambient temperature conditions could cause the product water to freeze and potentially damage system components. Additionally, a pump 92 may be located on the supply conduit 74 to increase pressure and ensure adequate flow of product water from the separator 70 to the spray nozzles 76. Further, as shown in FIG. 1, a back pressure control valve 94 and a silencer/diluter 96 may be disposed on the exhaust line 38. In the example embodiment, the back pressure control valve 94 is located downstream of the separator 70 and conduits 36, 62 and upstream of conduit 48, and the silencer/diluter 96 is located downstream of conduit 48.

With continued reference to FIG. 2, the liquid-gas separator 70 will be described in more detail. In the example embodiment, the separator 70 generally includes an accumulator vessel or housing 100 having an inlet port 102, a filter 104, a first outlet port 106, and a second outlet port 108. The inlet port 102 is configured to receive a mixture of gas/liquid water from the condenser 66. The filter 104 is configured to capture entrained liquid water particles from the gas flow leading to the first outlet port 106. The filter 104 may be, for example, an internal screen, fiber, or foam pad. The first outlet port 106 is configured to direct separated gas to the exhaust line 38, and the second outlet port 108 is configured to direct separated liquid water product to the spray nozzles 76.

The separator 70 may include a drain function to prevent damage in freezing temperatures. The controller 86 is configured to selectively drain liquid through the drain valve 90, which may be, for example, an electric solenoid valve or a bi-metal spring actuated drain valve. Further, when the controller 86 detects the liquid level in the separator 70 has exceeded a predetermined level (e.g., based on signals from sensor 84), the controller 86 may open drain valve 90 to drain the liquid water outside of the vehicle. If such drain functions are unavailable, the controller 86 may drain the liquid water to ambient via pump 92.

With continued reference to FIG. 1, in the example embodiment, the controller 86 is configured to optimize system power consumption by integrating control of the water spray on the radiator 78, the three-way control valve 60, FCS coolant pump 81, and electric fans 83. The controller 86 includes a predictive control strategy to change the state of the actuators (components above). Example control strategies include the following:

(1) A consumption rate of the water spray, including high load cases where it is required to avoid thermal de-rating the FCS power output, is based on route planning GPS data, map metadata, traffic and local temperature conditions. The predictive control stores water reserves in the separator 70 to match the high demand portion of the drive. Other times, the water spray is used to optimize electric power consumption on the fan(s).

(2) Control stores water in the separator 70 when ram air flow is sufficient to control the fuel cell stack temperature target.

(3) If the water reservoir in separator 70 reaches a predetermined “full” level, control starts the water spray function and reduces fan RPM such that the liquid water release to the environment is avoided.

(4) If ram air flow is insufficient to meet temperature targets, FCS heat rejection is greater than radiator heat dissipation, and control sprays water at a minimum rate that will increase the heat dissipation to match the heat rejection.

(5) If ram air flow with water spray results in heat dissipation less than heat rejection, control runs the fan(s).

(6) The water spray pump 92 may be utilized as part of the predictive control and, upon vehicle start, control utilizes a very low pump RPM to initiate water spray flow to avoid a fast, large coolant temperature change.

In the example embodiment, the controller 86 is configured to operate the fuel cell system 10 and/or thermal management system 12 in various operating modes. In a Start-Up Mode, the sensor 84 confirms if the separator 70 is empty, partially full, or full. Control enables an economy Eco-Mode if the water level is greater than empty, and enables a Performance Mode if the water level is full. If the water level is partially full, control determines if there is a potential thermal power de-rate of fuel cell power.

In the Eco-Mode, control monitors FCS coolant temperature, ambient temperature, separator reservoir water level, and pump status (e.g., ON/OFF), and subsequently determines minimum total power values for fan RPM. If the reservoir water level is less than partially full, Eco-Mode is disabled and FCS cooling depends on the electric fan power usage and is subject to thermal de-rating of the fuel cell power. When the water level reaches partially full, Eco-Mode is enabled and control supplies some water to the spray nozzles 76 while reserving a portion of water to increase the reservoir water level for a predicted high demand portion of the drive cycle. In this way, control sets a spray flow rate such that the reservoir water level reaches full within a predetermined amount of time (e.g., five minutes) following a vehicle start. When the water level meets or exceeds full, control increases the spray flow rate to a maximum rate or a rate that the FCS 14 is producing (product water) multiplied by a condenser effectiveness from the controller predictive thermal model. Additionally, a pump dry-run message on the CAN bus informs the controller 86 that a thermal de-rate condition could occur, and control increases fan RPM to maintain the coolant temperature target if additional fan RPM is available, or control indicates an impending thermal de-rate if additional fan RPM is not available.

In Performance Mode, depending on GPS map-based route planning data and ambient temperature, controller 86 sets the water pump 92 RPM to ensure spray water is available during the entire period of a high load fuel cell operating event. If the water level in the reservoir/separator 70 reaches the partially full level, control reduces pump flow rate to a value based on a calculation of product water steady-state condensing performance based on the gross power level in the FCS 14, ambient temperature, and vehicle speed (for ram air cooling) or available condenser fan RPM. If the pump 92 signals a dry-run, then control sets a flag for thermal de-rating FCS gross power. In a Shut-Down Mode, controller 86 drains the reservoir/separator 70 and pump 92 if the ambient temperature is less than a predetermined threshold (e.g., 10° C.). If the ambient temperature is greater than the predetermined threshold, control does not drain the reservoir/separator 70.

Described herein are systems and methods for thermal management of a fuel cell vehicle. The system directs water/air from the fuel cell stack exhaust to a condenser and subsequently to a water-gas separator pressure vessel that functions as a liquid reservoir. The liquid water is selectively supplied to spray nozzles to direct the liquid water onto a high temperature radiator for increased cooling of the fuel cell stack.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A thermal management system for a vehicle having a fuel cell stack, the thermal management system comprising:
a condenser fluidly coupled to the fuel cell stack to receive a flow of water/air exhaust therefrom;
a liquid-gas separator fluidly coupled to the condenser to receive the flow of water/air exhaust therefrom, the liquid-gas separator including a first outlet to direct separated gas to an exhaust line, and a second outlet for separated liquid water;
one or more spray nozzles fluidly coupled to the separator second outlet to receive a flow of liquid water therefrom; and
a coolant circuit configured to circulate a coolant to the fuel cell stack for cooling thereof, the coolant circuit including a radiator configured to cool the coolant,
wherein the one or more spray nozzles are configured to selectively spray the liquid water onto the radiator to increase cooling of the coolant and improve performance of the fuel cell stack.

2. The thermal management system of claim 1, further comprising an external membrane humidifier configured to receive the flow of water/air exhaust from the fuel cell stack and humidify a flow of air into the fuel cell stack before supplying the water/air exhaust flow to the condenser.

3. The thermal management system of claim 1, further comprising a three-way valve disposed upstream of the condenser and configured to selectively direct the flow of water/air exhaust to the condenser or the exhaust line.

4. The thermal management system of claim 1, wherein the exhaust line includes a back pressure control valve.

5. The thermal management system of claim 1, wherein the liquid-gas separator is a pressurized accumulator vessel.

6. The thermal management system of claim 5, wherein the liquid-gas separator includes a sensor configured to measure a liquid level in the liquid-gas separator.

7. The thermal management system of claim 6, further comprising:
a pump disposed between the second outlet and the one or more spray nozzles; and
a controller in signal communication with the sensor and the pump, the controller configured to control the flow of liquid water to the one or more spray nozzles based on the measured liquid level in the liquid-gas separator.

8. The thermal management system of claim 7, wherein when the measured liquid level meets or exceeds a predetermined full threshold, the controller commands the pump to provide a maximum flow rate to the one or more spray nozzles.

9. The thermal management system of claim 7, wherein the controller is configured to operate the thermal management system in a Performance Mode where, based on GPS map-based route planning data and ambient temperature, the controller sets an RPM of the pump to ensure liquid water is available to the one or more spray nozzles during a predicted high load fuel cell operating event.

10. The thermal management system of claim 7, wherein the controller is configured to operate the thermal management system in a Shut-Down Mode where the controller is configured to drain the liquid-gas separator if the ambient temperature is less than a predetermined threshold to thereby prevent freezing of the liquid water in the thermal management system.

11. The thermal management system of claim 7, wherein the controller is configured to operate the thermal management system in an Eco-Mode where, when the sensor indicates the liquid-gas separator is partially full, the controller is configured to supply liquid water to the one or more spray nozzles while reserving a portion of the liquid water to increase the water level in the liquid-gas separator for a predicted high-demand portion of a drive cycle.

12. The thermal management system of claim 1, wherein the condenser is a tube and fin heat exchanger with an electric fan configured to cool the water/air exhaust via heat exchange with ram air flow and/or airflow generated by the electric fan.

13. The thermal management system of claim 1, wherein the condenser is a tube heat exchanger configured to cool the water/air exhaust via heat exchange with ram air flow.

14. The thermal management system of claim 1, wherein the condenser is a liquid cooled heat exchanger thermally coupled to a second coolant circuit of the vehicle.

15. The thermal management system of claim 1, further comprising a drain valve disposed between the second outlet and the one or more spray nozzles, the drain valve configured to drain liquid water from the thermal management system to prevent damage thereof.

16. The thermal management system of claim 1, wherein the radiator is disposed between an A/C condenser and one or more electric fans.

17. The thermal management system of claim 1, wherein the liquid-gas separator includes a filter configured to capture entrained liquid water particles in the flow of water/air exhaust supplied to the liquid-gas separator.
